(19) United States
(12) Patent Application Publication
(10) Pub. No.: US 2011/0188039 A1
(43) Pub. Date: Aug. 4, 2011

(54) PARTICLE DETECTOR

(75) Inventor: Taku AOYAMA, Setagaya (JP)

(73) Assignee: SEIKO EPSON CORPORATION, Tokyo (JP)

(21) Appl. No.: 13/008,070

(22) Filed: Jan. 18, 2011

(30) Foreign Application Priority Data
Feb. 2, 2010 (JP) 2010-021284

(51) Int. Cl. G01N 21/53

(52) U.S. Cl. 356/338

(57) ABSTRACT

A particle detector includes: a gas cell in which a gaseous alkali metal atom is sealed; a light source that emits a plurality of coherent light beams containing first light and second light having different frequencies; a light detection unit that receives light and produces a detection signal according to the intensity of the received light, the light being emitted from the light source, passing through a space in which predetermined particles can be present, and being incident on the gas cell and passing therethrough before reaching the light detection unit; and an analysis assessor that performs analysis assessment of at least one of the following items based on the detection signal: whether or not the particles are present and the concentration thereof.

### BACKGROUND 1. Technical Field

The present invention relates to a particle detector that detects particles, such as smoke.

2. Related Art

In recent years, smoke sensors that sense smoke in the air have been widely used, for example, as fire alarm systems. At present, mainstream smoke sensors are based on a photoelectric effect, and the principle of these smoke sensors is based on the fact that light emitted from a light emitting diode is scattered when the light impinges on smoke. Specifically, a smoke sensor of this type senses smoke by using a light receiver so disposed that it is shifted from the optical path of the emitted light to detect change in intensity of the scattered light. In general, a photoelectric smoke sensor includes a labyrinth having a complicated shape to prevent malfunction of the sensor that may occur when the light receiver receives external light.

In the photoelectric smoke sensor described in JP-A-2007-309755, a wavelength selection filter is added to remove light having wavelengths different from that of the light emitted from a light emitting diode so that external light can be removed more reliably and the shape of a labyrinth is simplified. This configuration advantageously reduces not only the occurrence of malfunction that may occur when a light receiver receives external light but also, for example, the cost of the sensor because the shape of the labyrinth is simplified.

The photoelectric smoke sensor described in JP-A-2007-309755, however, still relies on detection of change in intensity of the scattered light as in a typical photoelectric smoke sensor, and hence the influence of external light cannot be totally eliminated. Any attempt to improve the precision and sensitivity in sensing smoke in the method of related art described above by reducing the influence of external light leads to a complicated structure of an enclosure of the smoke sensor, disadvantageously resulting in an increase in cost.

### SUMMARY

An advantage of some aspects of the invention is to provide a particle detector capable of detecting particles, such as smoke, with high precision and sensitivity without being affected by external light.

An aspect of the invention is directed to a particle detector including a gas cell in which a gaseous alkali metal atom is sealed, a light source that emits a plurality of coherent light beams containing first light and second light having different frequencies, a light detection unit that receives light and produces a detection signal according to the intensity of the received light, the light being emitted from the light source, passing through a space in which predetermined particles can be present, and being incident on the gas cell and passing therethrough before reaching the light detection unit, a frequency controller that controls the frequency of at least one of the first light and the second light in such a way that the first light and the second light form a pair of resonance light beams that cause the alkali metal atom to undergo an electromagnetically induced transparency phenomenon, and an analysis assessor that performs analysis assessment of at least one of the following items based on the detection signal: whether or not the particles are present and the concentration thereof.

In the particle detector according to the aspect of the invention, when no particle is present in the optical path from the light source to the gas cell, the first light and the second light emitted from the light source maintains their coherency and are incident on the gas cell. The first light and the second light form a pair of resonance light beams, which cause the alkali metal atom to undergo an electromagnetically induced transparency phenomenon, resulting in an increase in the intensity of the light received by the light detection unit. On the other hand, when the particles are present in the optical path from the light source to the gas cell, the first light and the second light emitted from the light source lose their coherency and are incident on the gas cell. The alkali metal atom therefore does not undergo an EIT phenomenon, resulting in a decrease in the intensity of the light received by the light detection unit. Since the detection signal produced by the light detection unit changes with the intensity of the received light, profile information on the detection signal changes sensitively in accordance with whether or not the particles are present and the difference in concentration of the particles. The particle detector according to the aspect of the invention can therefore determine whether or not the particles are present and detect the concentration thereof with high precision and sensitivity by using the analysis assessor to perform analysis assessment of the profile information.

Further, the particle detector according to the aspect of the invention can determine whether or not the particles are present and detect the concentration thereof without being affected by external light because only the light emitted from the light source forms a pair of resonance light beams. It is therefore unnecessary to provide a complicated mechanism for removing external light.

As described above, according to the aspect of the invention, a particle detector capable of detecting particles, such as smoke, with high precision and sensitivity without being affected by external light can be provided.

In the particle detector described above, the frequency controller may sweep the frequency of at least one of the first light and the second light within a predetermined frequency range so that the first light and the second light form the pair of resonance light beams, and the analysis assessor may acquire the detection signal at multiple timings at which the difference in frequency between the first light and the second light is changed and performs the analysis assessment based on the multiple acquired detection signals.

For example, the analysis assessor may compare the voltage of each of the detection signals produced by the light detection unit with a predetermined reference voltage and then assess whether or not the particles are present based on the comparison result (for example, when the voltage of the detection signal is higher than the reference voltage, it is assessed that no particle is present, whereas when the voltage of the detection signal is lower than the reference voltage, it is assessed that the particles are present.)

The particle detector described above sweeps the frequency of at least one of the first light and the second light within a predetermined frequency range and acquires the detection signal at multiple timings at which the difference in frequency between the first light and the second light is changed, whereby profile information, such as the peak value of each of the detection signals produced by the light detection unit within the frequency range and a frequency range over which the detection signal exceeds a predetermined threshold, can be acquired. The particle detector can therefore determine whether or not the particles are present and detect the concentration thereof with high precision and sensitivity by using the analysis assessor to perform the analysis assessment of the profile information.

In the particle detector described above, the frequency controller may perform the frequency control in such a way that the level of the detection signal is locally maximized, and the analysis assessor may compare the voltage of the detection signal with a predetermined threshold voltage and perform the analysis assessment based on the comparison result.

The particle detector described above performs the frequency control in such a way that the level of the detection signal produced by the light detection unit is locally maximized, that is, the intensity of the light received by the light detection unit is locally maximized. Since a state in which the intensity of the light received by the light detection unit is locally maximized corresponds to a state in which the amount of first light and second light, which form a pair of resonance light beams, is locally maximized, the local maximum of the detection signal changes very sensitively in accordance with whether or not the particles are present and the concentration thereof. The particle detector described above can therefore determine whether or not the particles are present and detect the concentration thereof with high precision and sensitivity by using the analysis assessor to perform the analysis assessment based on the comparison result between the level of the detection signal and the predetermined threshold.

The threshold voltage may be formed of a single value or multiple values. In the former case, whether or not the particles are present (whether the concentration of the particles is higher or lower than a predetermined concentration) can be assessed, whereas in the latter case, gradually changing concentration ((N+1) concentration values when the number of thresholds is N) of the particles can be assessed.

In the particle detector described above, the frequency controller may produce a modulation signal that allows the light source to undergo frequency modulation and control the frequency of the modulation signal in such a way that the level of the detection signal is locally maximized.

According to the particle detector described above, a single light source can produce the first light and the second light, which form a pair of resonance light beams, simultaneously and efficiently by allowing the light source to undergo frequency modulation.

In the particle detector described above, the analysis assessor may have tabulated information that defines the relationship between predetermined information on the detection signal and the concentration of the particles and perform the analysis assessment by referring to the tabulated information.

In this way, whether or not the particles are present and the concentration thereof can be readily assessed, for example, by creating in advance tabulated information, based on evaluation results or any other suitable results, that defines the relationship between predetermined information on the detection signal (such as information on the level of the detection signal) produced by the light detection unit and the concentration of the particles and referring to the tabulated information.

In the particle detector described above, the light source, the gas cell, and the light detection unit may be enclosed in a single enclosure. A first window through which light can pass may be provided in a first surface of the enclosure in such a way that the first window faces the light source, and a second window through which light can pass may be provided in a second surface of the enclosure in such a way that the second window faces the gas cell, the second surface facing the first surface with a space which the particles can enter interposed therebetween. The light emitted from the light source may pass through the first window and exit out of the enclosure, and the light having passed through the space, which the particles can enter, may externally pass through the second window of the enclosure and be incident on the gas cell.

In the configuration described above, since the light emitted from the light source passes through the external space and is then incident on the gas cell, whether or not the particles are present in the external space and the concentration of the particles can be assessed. It is therefore possible to provide a particle detector capable of assessing whether or not the particles are present and the concentration thereof and realized in a compact, integrated form in which a single enclosure accommodates the light source, the gas cell, and the light detection unit. The integrated particle detector described above can, for example, relatively readily replace integrated photoelectric smoke sensors that have been widely used.

In the particle detector described above, the light source, the gas cell, and the light detection unit may be enclosed in a single enclosure. A first window through which light can pass may be provided in a surface of the enclosure in such a way that the first window faces the light source, and a second window through which light can pass may be provided in the surface of the enclosure in such a way that the second window faces the gas cell. The light emitted from the light source may pass through the first window and exits out of the enclosure, and the light reflected off a reflector may externally pass through the second window of the enclosure and is incident on the gas cell.

In the configuration described above, since the light emitted from the light source is reflected off the external reflector and then incident on the gas cell, whether or not the particles are present in the optical path in the external space and the concentration of the particles can be assessed. It is therefore possible to provide a particle detector capable of assessing whether or not the particles are present and the concentration thereof and realized in a compact, integrated form in which a single enclosure accommodates the light source, the gas cell, and the light detection unit. Further, particles in a broader space can be detected by increasing the distance between the particle detector and the reflector or increasing the number of reflectors. Moreover, the particle detectable space can be readily changed in accordance with applications by changing the number of reflectors and the positions thereof.

In the particle detector described above, the light source may be enclosed in a first enclosure. The gas cell and the light detection unit maybe enclosed in a second enclosure. A first window through which light can pass may be provided in a surface of the first enclosure in such a way that the first window faces the light source, and a second window through which light can pass may be provided in a surface of the second enclosure in such a way that the second window faces the gas cell. The light emitted from the light source may pass through the first window and exit out of the first enclosure, externally pass through the second window of the second enclosure, and be incident on the gas cell.

In the configuration described above, since the light emitted from the light source passes through the external space and is incident on the gas cell, whether or not the particles are present in the external space and the concentration thereof can be assessed. Further, since the enclosure in which the light source is enclosed is separated from the enclosure in which the gas cell and the light detection unit are enclosed, that is, the particle detector is a separate-type apparatus in which the light emitter and the light receiver are separated from each other, the particle detectable space can be readily changed in accordance with applications by changing the positions of the light emitter and the light receiver even when no reflector is present.

### BRIEF DESCRIPTION OF THE DRAWINGS

The invention will be described with reference to the accompanying drawings, wherein like numbers reference like elements.

FIG. 1 is a functional block diagram of a particle detector of an embodiment.

FIG. 2 diagrammatically shows energy levels of an alkali metal atom.

FIG. 3 shows the configuration of a particle detector of a first embodiment.

FIG. 4 is a schematic view showing a frequency spectrum of emitted light in the first embodiment.

FIGS. 5A and 5B show exemplary EIT signals in the first embodiment.

FIGS. 6A and 6B show an exemplary embodiment of a particle detector.

FIGS. 7A and 7B show another exemplary embodiment of a particle detector.

FIGS. 8A and 8B show another exemplary embodiment of a particle detector.

FIG. 9 shows the configuration of a variation of the particle detector of the first embodiment.

FIG. 10 shows the configuration of a particle detector of a second embodiment.

### DESCRIPTION OF EXEMPLARY EMBODIMENTS

Exemplary embodiments of the invention will be described below in detail with reference to the drawings . The embodiments described below are not intended to inappropriately limit the contents of the invention set forth in the appended claims. Further, all the configurations described below are not necessarily essential in the invention.

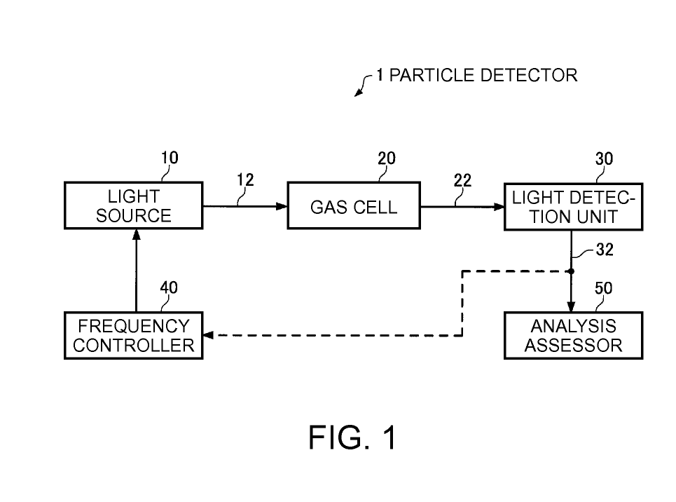

FIG. 1 is a functional block diagram of a particle detector of an embodiment.

The particle detector 1 of the present embodiment includes a light source 10, a gas cell 20, a light detection unit 30, a frequency controller 40, and an analysis assessor 50.

The gas cell 20 contains a gaseous alkali metal atom (such as sodium (Na) atom, rubidium (Rb) atom, and cesium (Cs) atom).

When an alkali metal atom is irradiated alone with coherent light having a specific wavelength (frequency) (laser light, for example), the alkali metal atom absorbs the light. The light is called resonance light. On the other hand, it is known that when the alkali metal atom is irradiated simultaneously with two types of resonance light having different wavelengths (frequencies), an electromagnetically induced transparency (EIT) phenomenon (also called a coherent population trapping (CPT) phenomenon) occurs, in which the alkali metal atom stops absorbing the resonance light.

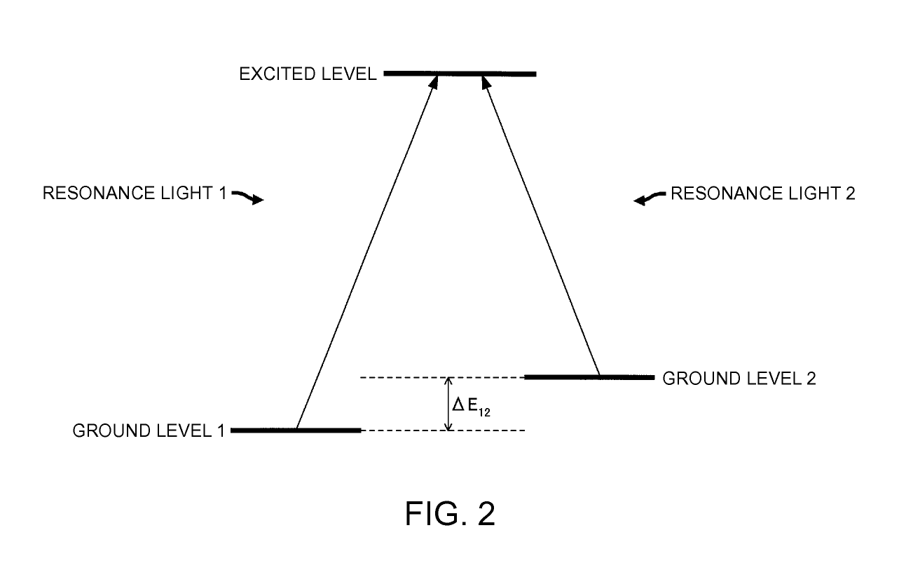

It is also known that the interaction between an alkali metal atom and two types of resonance light can be explained by using a Λ-type three-level system model, as shown in FIG. 2. An alkali metal atom has two ground levels (ground level 1 and ground level 2) and an excited level. The light absorption occurs when the alkali metal atom is irradiated alone with resonance light having a frequency corresponding to the difference in energy between the ground level 1 and the excited level (referred to as resonance light 1) or resonance light having a frequency corresponding to the difference in energy between the ground level 2 and the excited level (referred to as resonance light 2). On the other hand, when the alkali metal atom is irradiated simultaneously with the resonance light 1 and the resonance light 2, the state of the alkali metal atom transitions to a state in which the two ground levels are superimposed, that is, a quantum interference state, and the EIT phenomenon, in which the atom is not excited to the excited level, occurs. The difference in frequency between a pair of resonance light beams that causes the EIT phenomenon exactly coincides with the frequency corresponding to the difference in energy ΔE₁₂ between the two ground levels of the alkali metal atom.

For example, in a cesium atom, the ground state corresponding to the D2 line (wavelength of 852.1 nm) is split into two states having levels of F=3 and 4 due to an hyperfine structure of the atom, and the frequency corresponding to the difference in energy between the ground level 1 for F=3 and the ground level 2 for F=4 is 9.192631770 GHz. Therefore, when a cesium atom is irradiated simultaneously with two types of laser light that have wavelengths of approximately 852. 1 nm and produce difference in frequency of 9.192631770 GHz, an EIT phenomenon occurs because the two types of laser light form a pair of resonance light beams.

No EIT phenomenon will, however, occur when an alkali metal atom is irradiated with two types of incoherent light even if the difference in frequency between them exactly coincides with the frequency corresponding to ΔE₁₂. As will be described later, a particle detector 100A of the present embodiment detects particles with high precision and sensitivity by using the fact that the amount of alkali metal atom that causes an EIT phenomenon changes with the amount of particles.

The light source 10 emits a plurality of coherent light beams 12 containing first light and second light having different frequencies. For example, laser light is coherent light.

The light 12 emitted from the light source 10 (emitted light) passes through a space in which predetermined particles can be present and enters the gas cell 20. Conceivable examples of the particles include smoke, pollens, particles, water droplets, vapor, and steam.

The light detection unit 30 receives the light 22 having passed through the gas cell 20 (transmitted light) and produces a detection signal 32 according to the intensity of the received light.

The frequency controller 40 controls the frequency of at least one of the first light and the second light in such a way that the first light and the second light form a pair of resonance light beams that cause an alkali metal atom to undergo an EIT phenomenon. It is noted that the first light and the second light form a pair of resonance light beams not only when the difference in frequency between the first light and the second light exactly coincides with the frequency corresponding to the difference in energy between two ground levels of the alkali metal atom but also when the difference in frequency does not exactly coincides with the frequency described above but has a slight error that still allows the alkali metal atom to undergo the EIT phenomenon.

The analysis assessor 50 performs analysis assessment of at least one of the following items based on the detection signal 32: whether or not the particles are present and the concentration thereof.

The frequency controller 40 may, for example, sweep the frequency of at least one of the first light and the second light contained in the emitted light 12 from the light source 10 within a predetermined frequency range so that the first light and the second light form a pair of resonance light beams.

In this case, the analysis assessor 50 may acquire the detection signal 32 at multiple timings at which the difference in frequency between the first light and the second light is changed and then perform the analysis assessment of at least one of the following items based on the multiple acquired detection signals 32: whether or not the particles are present and the concentration thereof. For example, the analysis assessor 50 may acquire profile information on the peak value (local maximum), the line width, and other parameters of the pattern (called an EIT signal) of each of the detection signals 32 obtained in a range within which the alkali metal atom undergoes an EIT phenomenon and then perform the analysis assessment of at least one of the following items: whether or not the particles are present and the concentration thereof.

Alternatively, the frequency controller 40 may, for example, control the frequency of at least one of the first light and the second light in such a way that the level of the detection signal 32 is locally maximized. In this case, the analysis assessor 50 may compare the voltage of the detection signal 32 with a predetermined threshold voltage and then perform the analysis assessment of at least one of the following items based on the comparison result: whether or not the particles are present and the concentration thereof.

Still alternatively, the frequency controller 40 may, for example, produce a modulation signal that allows the light source 10 to undergo frequency modulation and control the frequency of the modulation signal in such a way that the level of the detection signal 32 is locally maximized.

Still alternatively, the analysis assessor 50 may, for example, have tabulated information that defines the relationship between predetermined information on the detection signal 32 and the concentration of the particles and then perform the analysis assessment of at least one of the following items: whether or not the particles are present and the concentration thereof by referring to the tabulated information. In the process described above, the level (local maximum) of the detection signal 32 can be the predetermined information when the frequency controller 40 controls the frequency of at least one of the first light and the second light in such a way that the level of the detection signal 32 is locally maximized. Alternatively, the peak value or the line width of an EIT signal, the difference in frequency between the first light and the second light that corresponds to the peak value, or other parameters, or any combination thereof can be the predetermined information when the frequency controller 40 sweeps the frequency of at least one of the first light and the second light within a predetermined frequency range.

A more specific configuration of the particle detector according to the present embodiment will be described below.

1. First Embodiment

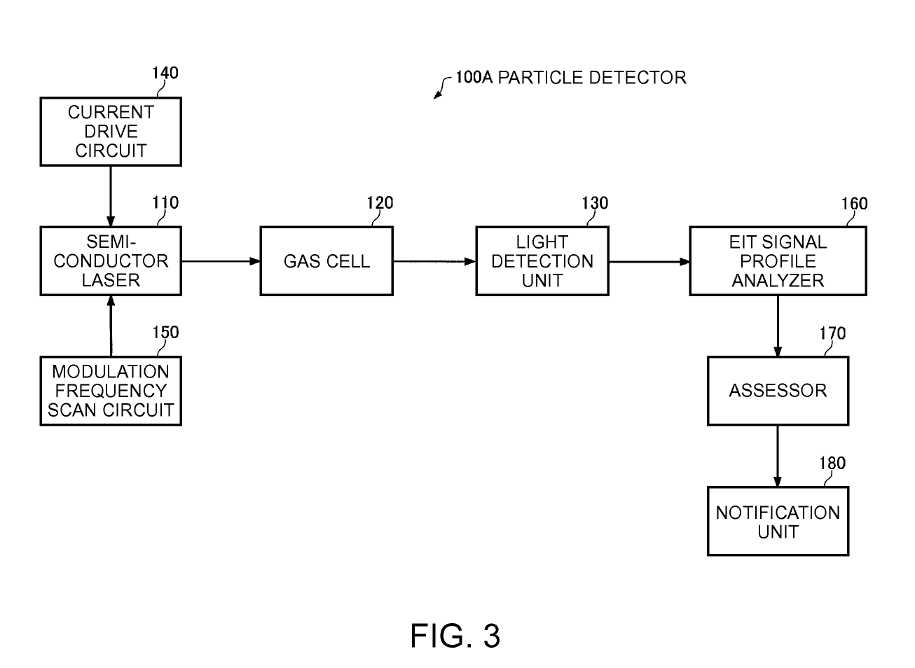

FIG. 3 shows the configuration of a particle detector of a first embodiment.

A particle detector 100A of the first embodiment includes a semiconductor laser 110, a gas cell 120, a light detection unit 130, a current drive circuit 140, a modulation frequency scan circuit 150, an EIT signal profile analyzer 160, an assessor 170, and a notification unit 180, as shown in FIG. 3.

The gas cell 120 has a container that seals a gaseous alkali metal atom.

The semiconductor laser 110 emits a plurality of light beams having different frequencies, with which the gas cell 120 is irradiated. Specifically, the current drive circuit 140 outputs a drive current to control the semiconductor laser 110 in such a way that the central wavelength λ₀ (central frequency f₀) of the light emitted therefrom coincides with the wavelength of a predetermined emission line from an alkali metal atom (D2 line from a cesium atom, for example). The semiconductor laser 110 then undergoes modulation using an output signal from the modulation frequency scan circuit 150 as a modulation signal (modulation frequency fₘ). That is, superimposing the output signal (modulation signal) from the modulation frequency scan circuit 150 on the drive current from the current drive circuit 140 allows the semiconductor laser 110 to emit modulated light. The semiconductor laser 110 can, for example, be an edge emitting laser, a vertical cavity surface emitting laser (VCSEL), or any other surface emitting laser.

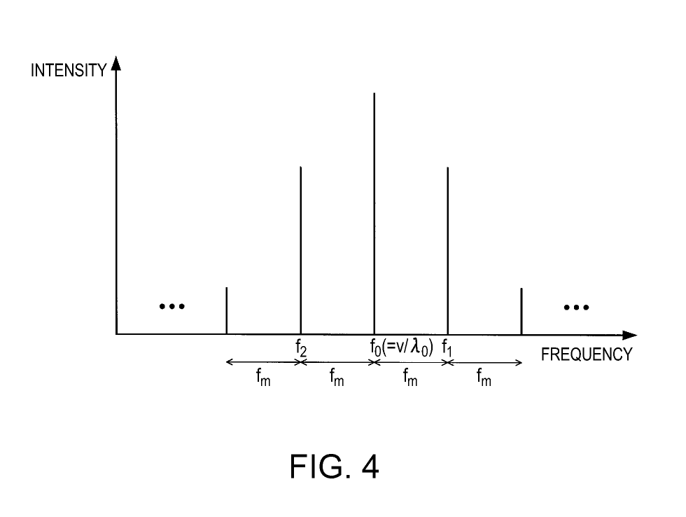

FIG. 4 is a schematic view showing a frequency spectrum of the light emitted from the semiconductor laser 110. In FIG. 4, the horizontal axis represents the frequency of the light, and the vertical axis represents the intensity of the light.

As shown in FIG. 4, the light emitted from the semiconductor laser 110 contains light having the central frequency f₀ (=v/λ₀ where v represents the speed of light and λ₀ represents the wavelength of the light) and multiple types of light located on both sides of the central frequency f₀ and having frequencies spaced apart at intervals fₘ.

The light detection unit 130 detects the light having passed through the gas cell 120 (transmitted light) and outputs a detection signal according to the intensity of the detected light. As described above, an EIT phenomenon occurs when an alkali metal atom is irradiated with two types of coherent light the difference in frequency between which coincides with a frequency f₁₂ corresponding to ΔE₁₂. The intensity of the light passing through the gas cell 120 (transmitted light) increases with the number of alkali metal atoms that undergo the EIT phenomenon, and hence the voltage level of the output signal (detection signal) from the light detection unit 130 increases. The degree (quality) of coherency of the two types of light also affects the EIT phenomenon. Degraded coherency reduces the intensity of the transmitted light under the EIT phenomenon, and the voltage level of the output signal (detection signal) from the light detection unit 130 decreases accordingly.

It is noted that the pattern of an EIT signal changes sensitively in accordance with the amount of particles present in the optical path because the coherency of the laser light emitted from the semiconductor laser 110 is degraded when the laser light impinges on the particles. It is therefore possible, for example, to determine whether or not particles whose size is greater than or equal to a reference value are present in the optical path and detect the amount of particles present in the optical path based on the pattern of the EIT signal.

In the present embodiment, the modulation frequency scan circuit 150 sweeps the frequency fₘ of the output signal therefrom to change the frequency difference between the two types of first-order sideband light contained in the light emitted from the semiconductor laser 110, that is, the frequency difference f₁ (=f₀+fₘ) −f₂ (=f₀−fₘ) (=2×fₘ) between light having the frequency f₁ and light having the frequency f₂, within a range f₁₂±δ. The sweeping operation produces an EIT signal in the output signal (detection signal) from the light detection unit 130.

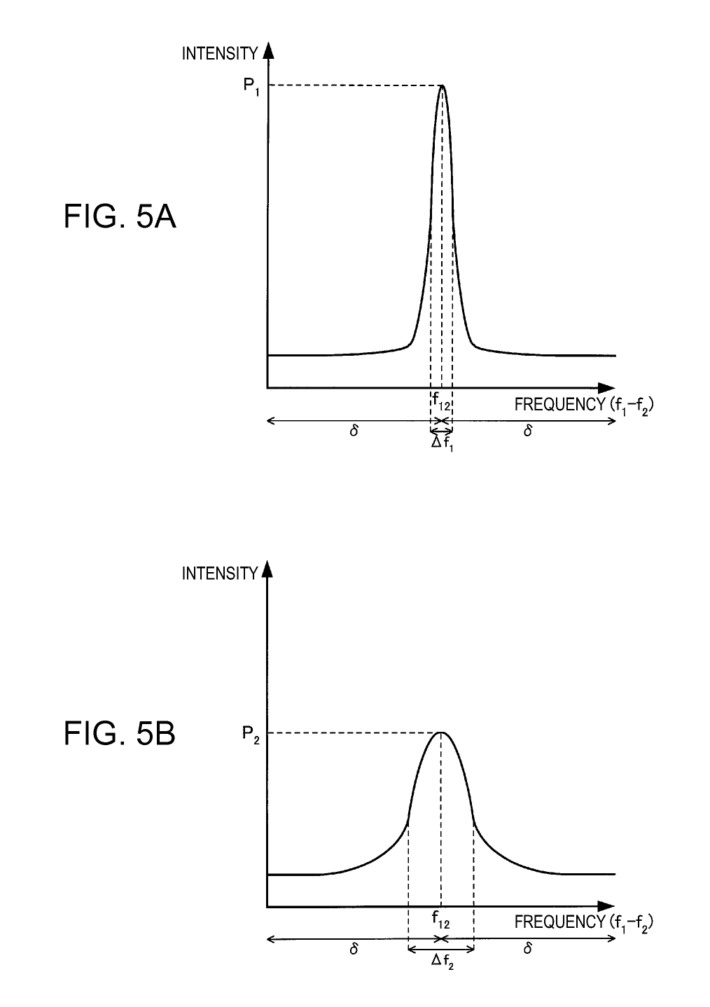

FIG. 5A shows an exemplary EIT signal obtained when very few particles are present in the optical path of the light emitted from the semiconductor laser 110, and FIG. 5B shows an exemplary EIT signal obtained when quite a few particles are present in the optical path of the light emitted from the semiconductor laser 110. In FIGS. 5A and 5B, the horizontal axis represents the frequency difference f₁−f₂ between the two types of light, and the vertical axis represents the intensity of the transmitted light.

When very few particles are present in the optical path, an EIT signal having a large peak value (P₁) and a narrow line width (full width at half maximum of detected intensity, Δf₁) is obtained, as shown in FIG. 5A. On the other hand, when quite a few particles are present in the optical path, an EIT signal having a small peak value (P₂) and a broad line width (full width at half maximum of detected intensity, Δf₂) is obtained, as shown in FIG. 5B. It is conceivable in some cases that the frequency difference f₁−f₂ corresponding to the peak value of an EIT signal shifts from f₁₂. The peak value, the line width, and the frequency difference corresponding to the peak value, and other parameters vary sensitively in accordance with the amount of particles.

The EIT signal profile analyzer 160 samples the output signal (detection signal) from the light detection unit 130 and uses the pattern of the detection signal to analyze the profile of the EIT signal. When quite a few particles are present in the optical path of the light emitted from the semiconductor laser 110, the EIT signal shown in FIG. 5B is obtained. Therefore, information on the peak value or the line width of the EIT signal is used as the profile information, or the frequency difference corresponding to the peak value is used as the profile information in some cases.

The assessor 170 performs predetermined assessment based on the analysis result obtained from the EIT signal profile analyzer 160. For example, the assessor 170 may assess whether or not particles are present (whether or not the concentration of the particles is greater than or equal to a predetermined value) or may assess (calculate) the concentration of the particles itself. The assessment can be performed, for example, by storing in advance as tabulated information the relationship between profile information on EIT signals and information on the concentration of particles based on experience and evaluation results and calculating concentration information by referring to the tabulated information. In this way, whether or not particles are present and the concentration thereof can be readily assessed by referring to the tabulated information.

The notification unit 180 notifies an apparatus external to the particle detector of the assessment result obtained from the assessor 170. The notification unit 180 may, for example, output a warning message on a display, output a warning sound from a loudspeaker, display information on the concentration of the particles, or send such information to a host computer when the concentration of the particles is greater than or equal to a predetermined value.

The semiconductor laser 110, the gas cell 120, and the light detection unit 130 correspond to the light source 10, the gas cell 20, and the light detection unit 30 shown in FIG. 1, respectively. Further, the combination of the current drive circuit 140 and the modulation frequency scan circuit 150 corresponds to the frequency controller 40 shown in FIG. 1, and the combination of the EIT signal profile analyzer 160 and the assessor 170 corresponds to the analysis assessor 50 shown in FIG. 1.

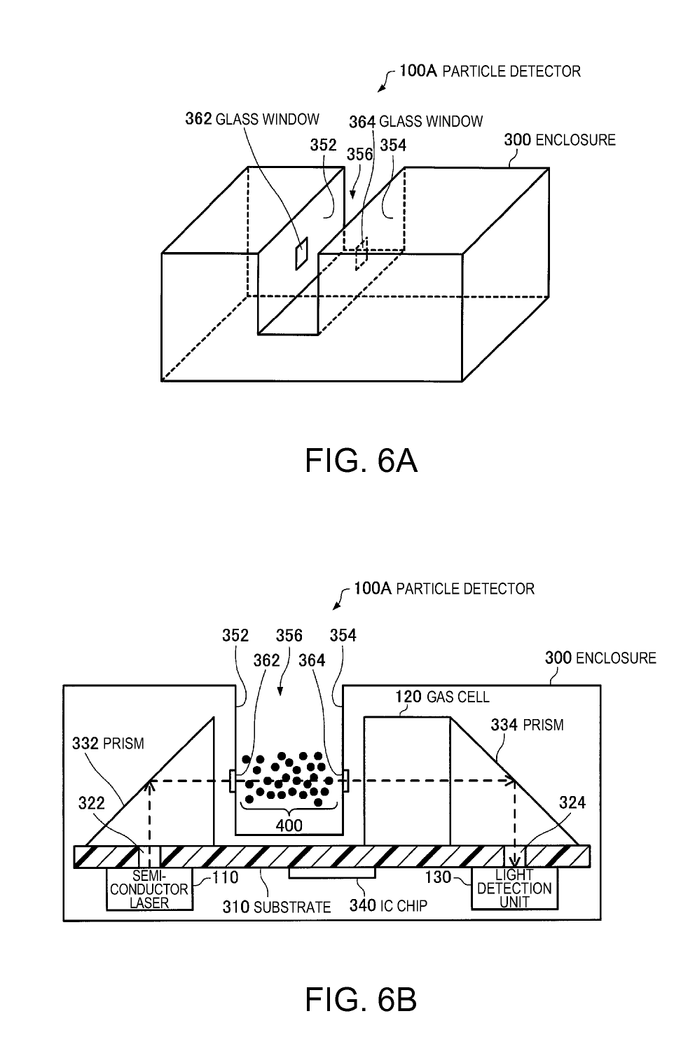

The thus configured particle detector 100A can be provided in a variety of other forms. For example, the particle detector 100A can alternatively be provided in the form shown in FIGS. 6A and 6B. FIG. 6A is a schematic perspective view of another particle detector 100A, and FIG. 6B is a schematic cross-sectional view of the particle detector 100A shown in FIG. 6A.

In the form shown in FIGS. 6A and 6B, the particle detector 100A is enclosed in an enclosure 300 having a recess 356 that particles 400 can enter. A substrate 310 is provided in the enclosure 300. The gas cell 120 and two prisms 332 and 334 are provided on the front surface of the substrate 310. The semiconductor laser 110, the light detection unit 130, and an IC chip 340 connected to the semiconductor laser 110 and the light detection unit 130 via wiring lines are provided on the rear surface of the substrate 310. In the IC chip 340 are implemented, for example, not only the current drive circuit 140 and the modulation frequency scan circuit 150 as dedicated circuits but also a CPU that functions as the EIT signal profile analyzer 160, the assessor 170, and the notification unit 180.

The substrate 310 has an opening 322 in a position corresponding to the optical path of the light emitted from the semiconductor laser 110 and an opening 324 in a position corresponding to the optical path of the light to be received by the light detection unit 130. Side surfaces 352 and 354 that form the recess 356 of the enclosure 300 have glass windows 362 and 364, respectively.

The light emitted from the semiconductor laser 110 passes through the opening 322 and is incident on the prism 332, and the light reflected off the prism 332 passes through the glass windows 362 and 364 and is incident on the gas cell 120. The light having passed through the gas cell 120 is incident on the prism 334, and the light reflected off the prism 334 passes through the opening 324 and is received by the light detection unit 130.

In the particle detector 100A having the structure described above, when particles 400 enter the recess 356, the pattern of an EIT signal changes in accordance with the concentration of the particles 400 present in the optical path, whereby whether or not the particles 400 are present can be determined and the concentration thereof can be detected.

The thus integrated particle detector can, for example, relatively readily replace integrated photoelectric smoke sensors that have been widely used.

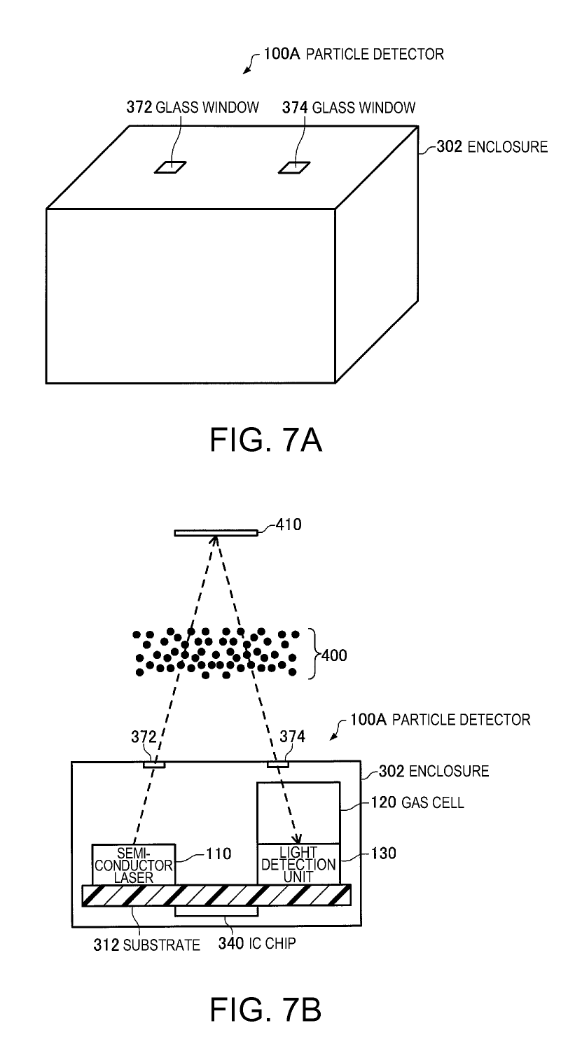

The particle detector 100A can alternatively be provided, for example, in the form shown in FIGS. 7A and 7B. FIG. 7A is a schematic perspective view of another particle detector 100A, and FIG. 7B is a schematic cross-sectional view of the particle detector 100A shown in FIG. 7A.

In the form shown in FIGS. 7A and 7B, the particle detector 100A is enclosed in an enclosure 302 having two glass windows 372 and 374 provided in a surface thereof. A substrate 312 is provided in the enclosure 302. The semiconductor laser 110 and the light detection unit 130 are provided on the front surface of the substrate 312. An IC chip 340 is provided on the rear surface of the substrate 312. In the IC chip 340 are implemented, for example, not only the current drive circuit 140 and the modulation frequency scan circuit 150 as dedicated circuits but also a CPU that functions as the EIT signal profile analyzer 160, the assessor 170, and the notification unit 180.

The gas cell 120 is disposed on the light-receiving side of the light detection unit 130. The glass window 372 is disposed in a position corresponding to the optical path of the light emitted from the semiconductor laser 110, and the glass window 374 is disposed in a position corresponding to the optical path of the light to be received by the light detection unit 130.

The light emitted from the semiconductor laser 110 passes through the glass window 372 and is incident on a reflector 410 (mirror, for example), and the light reflected off the reflector 410 passes through the glass window 374 and is incident on the gas cell 120. The light having passed through the gas cell 120 is received by the light detection unit 130. The reflector 410 may be separated by an arbitrary distance to the extent that the laser light can reach the reflector 410.

A plurality of reflectors 410 can be disposed so that the light emitted from the semiconductor laser 110 is reflected multiple times off the reflectors 410 and then received by the light detection unit 130. In this way, whether or not the particles 400 are present in a broader space can be determined, and the concentration of the particles 400 can be detected.

In the particle detector 100A having the structure described above, when particles 400 are present in the space between the particle detector 100A and the reflector 410, the pattern of an EIT signal changes in accordance with the concentration of the particles 400 present in the optical path, whereby whether or not the particles 400 are present can be determined and the concentration thereof can be detected.

Particles in a broader space can be detected by increasing the distance between the particle detector 100A and the reflector 410 or increasing the number of reflectors 410. Further, the particle detectable space can be readily changed in accordance with applications by changing the number of reflectors 410 and the positions thereof.

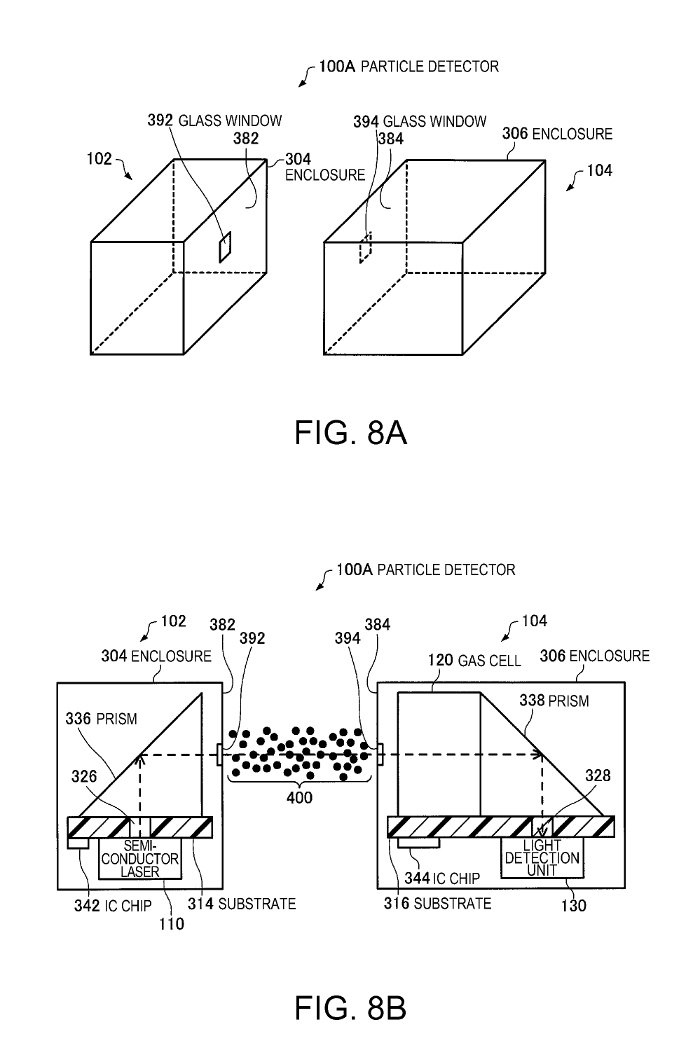

The particle detector 100A can alternatively be provided in the form shown in FIGS. 8A and 8B. FIG. 8A is a schematic perspective view of another particle detector 100A, and FIG. 8B is a schematic cross-sectional view of the particle detector 100A shown in FIG. 8A.

In the form shown in FIGS. 8A and 8B, the particle detector 100A is formed of a light emitter 102 and a light receiver 104 physically separated from each other. The light emitter 102 is enclosed in an enclosure 304, and a glass window 392 is provided in a side surface 382 of the enclosure 304. The light receiver 104 is enclosed in an enclosure 306, and a glass window 394 is provided in a side surface 384 of the enclosure 306. The light emitter 102 and the light receiver 104 are so disposed that the glass windows 392 and 394 face each other.

A substrate 314 is provided in the enclosure 304 for the light emitter 102. A prism 336 is provided on the front surface of the substrate 314. The semiconductor laser 110 and an IC chip 342 connected thereto via wiring lines are provided on the rear surface of the substrate 314. The current drive circuit 140 and the modulation frequency scan circuit 150 are implemented in the IC chip 342. An opening 326 is also provided in the substrate 314 in a position corresponding to the optical path of the light emitted from the semiconductor laser 110. The light emitted from the semiconductor laser 110 passes through the opening 326 and is incident on the prism 336, and the light reflected off the prism 336 exits through the glass window 392.

A substrate 316 is provided in the enclosure 306 for the light receiver 104. The gas cell 120 and a prism 338 are provided on the front surface of the substrate 316. The light detection unit 130 and an IC chip 344 connected thereto via wiring lines are provided on the rear surface of the substrate 316. In the IC chip 344 is implemented a CPU that functions as the EIT signal profile analyzer 160, the assessor 170, and the notification unit 180. The substrate 316 also has an opening 328 provided in a position corresponding to the optical path of the light to be received by the light detection unit 130. The light having exited through the glass window 392 of the light emitter 102 passes through the glass window 394 of the light receiver 104 and is incident on the gas cell 120. The light having passed through the gas cell 120 is incident on the prism 338, and the light reflected off the prism 338 passes through the opening 328 and is received by the light detection unit 130.

The light emitter 102 and the light receiver 104 may be separated from each other by an arbitrary distance to the extent that the laser light can reach the light receiver 104.

In the particle detector 100A having the structure described above, when particles 400 are present in the space between the side surface 382 of the light emitter 102 and the side surface 384 of the light receiver 104, the pattern of an EIT signal changes in accordance with the concentration of the particles 400 present in the optical path, whereby whether or not the particles 400 are present can be determined and the concentration thereof can be detected.

Since the particle detector 100A described above is a separate-type apparatus formed of the light emitter 102 and the light receiver 104 separated from each other, the particle detectable space can be readily changed in accordance with applications by changing the positions of the light emitter 102 and the light receiver 104 without the reflector shown in FIG. 7B.

Alternatively, the particle detector 100A described above can be so configured that the light emitted from the semiconductor laser 110 is reflected off at least two reflectors and then received by the light detection unit 130. It is unnecessary in this case to dispose the light emitter 102 and the light receiver 104 in such a way that the glass windows 392 and 394 face each other. Whether or not the particles 400 are present in a broader space can be determined and the concentration of the particles 400 can be detected by using the reflector as described above.

As described above, in the particle detector of the first embodiment, when no particle, such as smoke, is present in the optical path from the semiconductor laser 110 to the gas cell 120, the light emitted from the semiconductor laser 110 maintains its coherency and is incident on the gas cell 120. Two types of light the difference in frequency between which is equal to the frequency corresponding to ΔE₁₂ therefore form a pair of resonance light beams, which cause an alkali metal atom to undergo an EIT phenomenon, and an EIT signal having a large peak value and a narrow line width is obtained. On the other hand, when particles, such as smoke, are present in the optical path from the semiconductor laser 110 to the gas cell 120, the portion of the light emitted from the semiconductor laser 110 that impinges on the particles loses its coherency and is incident on the gas cell 120. The two types of light having impinged on the particles, even when the difference in frequency between the two types of light is equal to the frequency corresponding to ΔE₁₂, do not cause the alkali metal atom to undergo an EIT phenomenon, and an EIT signal having a small peak value and a broad line width is obtained.

Since the profile information, such as the peak value and the line width of an EIT signal, changes sensitively in accordance with whether or not particles are present and the difference in concentration of the particles, the particle detector of the first embodiment can determine whether or not the particles are present and detect the concentration thereof with high precision and sensitivity by using the EIT signal profile analyzer 160 and the assessor 170 to perform analysis assessment of the profile information. Further, according to the particle detector of the first embodiment, since only the light emitted from the semiconductor laser 110 forms a pair of resonance light beams, whether or not particles are present can be determined and the concentration of the particles can be detected without being affected by external light. It is therefore unnecessary to provide a complicated mechanism for removing external light.

As described above, according to the first embodiment, a particle detector capable of detecting particles, such as smoke, with high precision and sensitivity without being affected by external light can be provided.

Variation

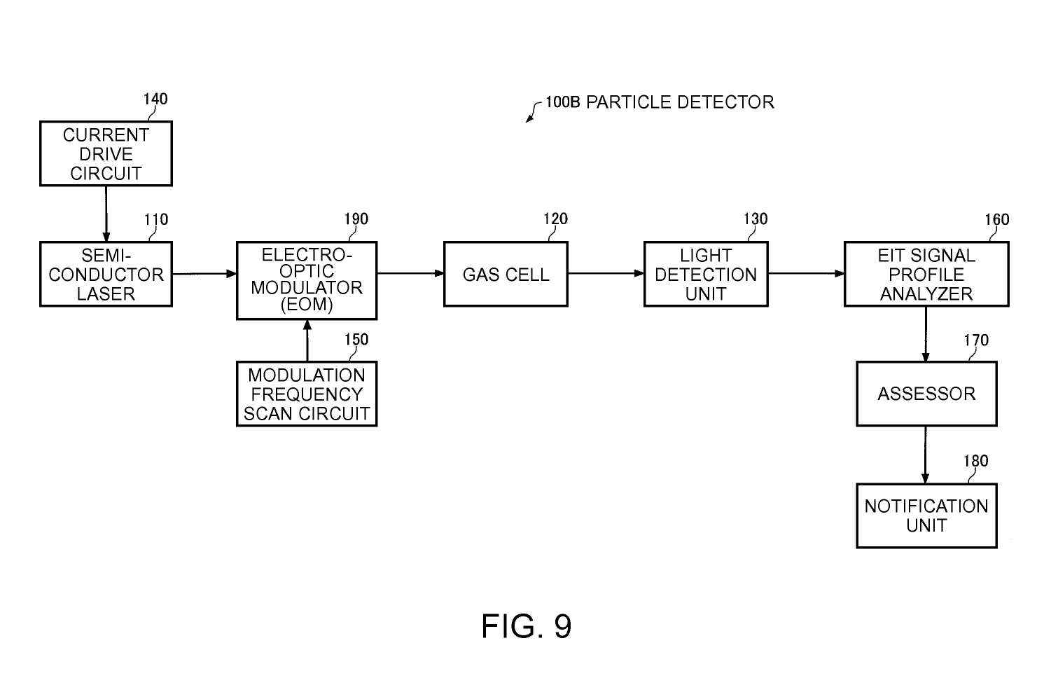

FIG. 9 shows the configuration of a variation of the particle detector according to the first embodiment. As shown in FIG. 9, a particle detector 100B of the variation differs from the particle detector 100A shown in FIG. 3 in that an electro-optic modulator (EOM) 190 is added.

In the particle detector 100B, the semiconductor laser 110 does not undergo modulation using the output signal (modulation signal) from the modulation frequency scan circuit 150, as shown in FIG. 9, and hence produces light of a single frequency f₀. The light of the single frequency f₀ is incident on the electro-optic modulator (EOM) 190 and undergoes modulation using the output signal (modulation signal) from the modulation frequency scan circuit 150. As a result, light having the same frequency spectrum as that shown in FIG. 4 can be produced.

The other components in the particle detector 100B shown in FIG. 9 are the same as those in the particle detector 100A shown in FIG. 3 and hence have the same reference numbers, and no description of these components will be made.

The electro-optic modulator (EOM) 190 may be replaced with an acousto-optic modulator (AOM).

The combination of the semiconductor laser 110 and the electro-optic modulator (EOM) 190 corresponds to the light source 10 shown in FIG. 1. The other components are the same as those in the particle detector 100A shown in FIG. 3.

The configuration of the variation also allows a particle detector having the same function and advantageous effect as those of the particle detector 100A to be provided.

2. Second Embodiment

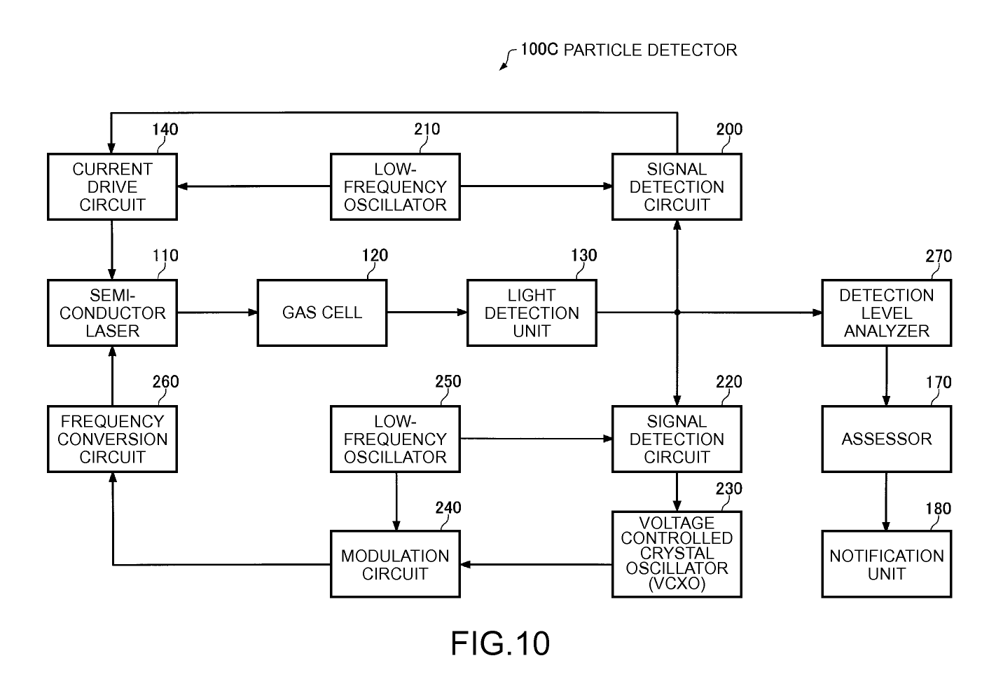

FIG. 10 shows the configuration of a particle detector of a second embodiment. In FIG. 10, the same components as those shown in FIG. 3 have the same reference numbers, and description thereof will be omitted or simplified.

As shown in FIG. 10, a particle detector 100C of the second embodiment includes the semiconductor laser 110, the gas cell 120, the light detection unit 130, a signal detection circuit 200, a low-frequency oscillator 210, the current drive circuit 140, a signal detection circuit 220, a voltage controlled crystal oscillator (VCXO) 230, a modulation circuit 240, a low-frequency oscillator 250, a frequency conversion circuit 260, a detection level analyzer 270, the assessor 170, and the notification unit 180.

The light emitted from the semiconductor laser 110 irradiates the gas cell 120, and the light detection unit 130 detects the light having passed through the gas cell 120 (transmitted light) and outputs a detection signal according to the intensity of the detected light, as in the particle detector 100A of the first embodiment.

The output signal from the light detection unit 130 is inputted to the signal detection circuits 200 and 220. The signal detection circuit 200 uses an oscillating signal outputted from the low-frequency oscillator 210 and oscillating at a low frequency ranging approximately from several Hz to several hundred Hz to synchronously detect the output signal (detection signal) from the light detection unit 130.

The current drive circuit 140 produces a drive current having a magnitude according to an output signal from the signal detection circuit 200 and supplies the drive current to the semiconductor laser 110 to control the central frequency f₀ (central wavelength λ₀) of the light emitted therefrom. To allow the signal detection circuit 200 to perform the synchronous detection, the oscillating signal from the low-frequency oscillator 210 (the same signal as the oscillating signal supplied to the signal detection circuit 200) is superimposed on the drive current produced by the current drive circuit 140.

The feedback loop that involves the semiconductor laser 110, the gas cell 120, the light detection unit 130, the signal detection circuit 200, and the current drive circuit 140 allows the central frequency f₀ (central wavelength λ₀) of the light produced by the semiconductor laser 110 to be minutely adjusted so as to coincide with the wavelength of a predetermined emission line of an alkali metal atom (D2 line from a cesium atom, for example).

The signal detection circuit 220 uses an oscillating signal outputted from the low-frequency oscillator 250 and oscillating at a low frequency ranging approximately from several Hz to several hundred Hz to synchronously detect the output signal (detection signal) from the light detection unit 130. The oscillating frequency of the voltage controlled crystal oscillator (VCXO) 230 is minutely adjusted in accordance with the magnitude of an output signal from the signal detection circuit 220. The voltage controlled crystal oscillator (VCXO) 230 may, for example, be configured to oscillate approximately at several MHz.

To allow the signal detection circuit 220 to perform the synchronous detection, the modulation circuit 240 uses the oscillating signal from the low-frequency oscillator 250 (the same oscillating signal as that supplied to the signal detection circuit 220) as a modulation signal to modulate an output signal from the voltage controlled crystal oscillator (VCXO) 230. The modulation circuit 240 can, for example, be a frequency mixer, a frequency modulation (FM) circuit, or an amplitude modulation (AM) circuit.

The frequency conversion circuit 260 converts an output signal from the modulation circuit 240 into a signal in a frequency band including one-half the frequency f₁₂ corresponding to ΔE₁₂. The frequency conversion circuit 260 can, for example, be a phase locked loop (PLL) circuit.

The feedback loop that involves the semiconductor laser 110, the gas cell 120, the light detection unit 130, the signal detection circuit 220, the voltage controlled crystal oscillator (VCXO) 230, the modulation circuit 240, and the frequency conversion circuit 260 allows the frequency (modulation frequency fₘ) of an output signal from the frequency conversion circuit 260 to be minutely adjusted so as to exactly coincide with one-half the frequency f₁₂. For example, when the alkali metal atom in question is a cesium atom, the frequency f₁₂ is 9.192631770 GHz, and the modulation frequency fₘ is 4.596315885 GHz.

Superimposing the output signal from the frequency conversion circuit 260 on the drive current from the current drive circuit 140 allows the semiconductor laser 110 to undergo modulation using the output signal from the frequency conversion circuit 260 as a modulation signal (modulation frequency fₘ). As a result, the semiconductor laser 110 emits light having the frequency spectrum shown in FIG. 4.

As described above, since the control is so performed that the frequency difference f₁−f₂ (=2×fₘ) between two types of first-order sideband light exactly coincides with f₁₂, the level of the output signal (detection signal) from the light detection unit 130 corresponds to the peak value (local maximum) of the EIT signal described in FIG. 5A or 5B.

The detection level analyzer 270 samples the output signal (detection signal) from the light detection unit 130 and analyzes the level of the detection signal.

The assessor 170 performs predetermined assessment based on the analysis result obtained from the detection level analyzer 270. The assessor 170 may assess whether or not particles are present (whether or not the concentration of the particles is greater than or equal to a predetermined value) or may assess (calculate) the concentration of the particles itself, as in the particle detector 100A of the first embodiment.

For example, the detection level analyzer 270 may compare the voltage of the output signal (detection signal) from the light detection unit 130 with a predetermined threshold voltage, and the assessor 170 may assess whether or not particles are present or the concentration thereof based on the comparison result obtained from the detection level analyzer 270.

The notification unit 180 notifies an apparatus external to the particle detector of the assessment result obtained from the assessor 170. The notification unit 180 may, for example, output a warning message on a display, output a warning sound from a loudspeaker, display information on the concentration of the particles, or send such information to a host computer when the concentration of the particles is greater than or equal to a predetermined value, as in the particle detector 100A of the first embodiment.

The semiconductor laser 110, the gas cell 120, and the light detection unit 130 correspond to the light source 10, the gas cell 20, and the light detection unit 30 shown in FIG. 1, respectively. Further, the combination of the signal detection circuit 200, the low-frequency oscillator 210, the current drive circuit 140, the signal detection circuit 220, the voltage controlled crystal oscillator (VCXO) 230, the modulation circuit 240, the low-frequency oscillator 250, and the frequency conversion circuit 260 corresponds to the frequency controller 40 shown in FIG. 1, and the combination of the detection level analyzer 270 and the assessor 170 corresponds to the analysis assessor 50 shown in FIG. 1.

The thus configured particle detector 100C can be provided in a variety of other forms. For example, the particle detector 100C may alternatively be provided in the same variety of forms as those of the particle detector 100A of the first embodiment described above. When the particle detector 100C is provided in the form shown in FIGS. 6A and 6B or in the form shown in FIGS. 7A and 7B, in the IC chip 340 are implemented, for example, not only the signal detection circuit 200, the low-frequency oscillator 210, the current drive circuit 140, the signal detection circuit 220, the voltage controlled crystal oscillator (VCXO) 230, the modulation circuit 240, the low-frequency oscillator 250, and the frequency conversion circuit 260 as dedicated circuits but also a CPU that functions as the detection level analyzer 270, the assessor 170, and the notification unit 180.

The thus configured particle detector 100C may alternatively be provided in the form shown in FIGS. 8A and 8B. For example, since the light emitter 102 and the light receiver 104 are physically separated from each other, connectors are provided on the enclosures 304 and 306, and the two connectors are connected to each other, for example, with a signal transfer cable. In this way, the substrates 314 and 316 can be electrically connected to each other, whereby the form shown in FIGS. 8A and 8B can be achieved.

As described above, in the particle detector of the second embodiment, when no particle, such as smoke, is present in the optical path from the semiconductor laser 110 to the gas cell 120, the light emitted from the semiconductor laser 110 maintains its coherency and is incident on the gas cell 120. Two types of light the difference in frequency between which is equal to the frequency f₁₂ corresponding to ΔE₁₂ therefore form a pair of resonance light beams, which cause an alkali metal atom to undergo an EIT phenomenon, and the light detection unit 130 produces a high-level output signal (detection signal) . On the other hand, when particles, such as smoke, are present in the optical path from the semiconductor laser 110 to the gas cell 120, the portion of the light emitted from the semiconductor laser 110 that impinges on the particles loses its coherency and is incident on the gas cell 120. Two types of light having impinged on the particles, even when the difference in frequency between the two types of light is equal to the frequency corresponding to ΔE₁₂, do not cause the alkali metal atom to undergo an EIT phenomenon, and the light detection unit 130 produces a low-level output signal (detection signal).

Since the level of the output signal (detection signal) from the light detection unit 130 changes sensitively in accordance with whether or not particles are present and the difference in concentration of the particles, the particle detector of the second embodiment can determine whether or not the particles are present and detect the concentration thereof with high precision and sensitivity by using the detection level analyzer 270 and the assessor 170 to perform analysis assessment of the level of the output signal (detection signal) from the light detection unit 130. Further, according to the particle detector of the second embodiment, since only the light emitted from the semiconductor laser 110 forms a pair of resonance light beams, whether or not particles are present can be determined and the concentration of the particles can be detected without being affected by external light. It is therefore unnecessary to provide a complicated mechanism for removing external light.

As described above, according to the second embodiment, a particle detector capable of detecting particles, such as smoke, with high precision and sensitivity without being affected by external light can be provided.

Variation

In the second embodiment, as in the configuration of the variation of the particle detector according to the first embodiment, the semiconductor laser 110 does not undergo modulation and hence produces light of a single frequency f₀. The light emitted from the semiconductor laser 110 may undergo modulation using the output signal (modulation signal) from the frequency conversion circuit 260 in an electro-optic modulator (EOM) or an acousto-optic modulator (AOM) to produce light having the same frequency spectrum as that shown in FIG. 4.

The configuration of the variation also allows a particle detector having the same function and advantageous effect as those of the particle detector 100C to be provided.

The invention is not limited to the embodiments described above but can be implemented in a variety of variations within the substance of the invention.

For example, in the first and second embodiments, the semiconductor laser 110 is so controlled that two types of first-order sideband light (having frequencies f₀±fₘ) in the light emitted from the semiconductor laser 110 form a pair of resonance light beams, that is, the difference in frequency between the two types of light is the frequency f₁₂=2fₘ corresponding to ΔE₁₂, but the control is not necessarily performed this way. For example, in the first and second embodiments, the semiconductor laser 110 may be so controlled that the light having the central frequency f₀ and the light having the frequency f₀+fₘ form a pair of resonance light beams and the light having the central frequency f₀ and the light having the frequency f₀−fₘ form a pair of resonance light beams, that is, the difference in frequency between the two types of light is f₁₂=fₘ corresponding to ΔE₁₂.

Further, for example, in the first and second embodiments, a pair of resonance light beams is produced by modulating a single semiconductor laser. A pair of resonance light beams may alternatively be produced in a simpler manner by driving two semiconductor lasers with different drive currents . In this case, in the first embodiment, in particular, the modulation frequency scan circuit 150 may not change the frequency of the light emitted from one of the semiconductor lasers but may sweep the frequency of the light emitted from the other semiconductor laser, or the modulation frequency scan circuit 150 may sweep both the frequencies of the light emitted from the semiconductor lasers.

The invention encompasses a configuration that is substantially the same as the configuration described with reference to any of the embodiments (for example, a configuration that provides the same function, method, and result or a configuration that achieves the same purpose and provides the same effect). The invention further encompasses a configuration in which a portion that is not essential in the configuration described with reference to any of the embodiments is replaced. The invention further encompasses a configuration that provides the same advantageous effect or achieves the same purpose as that provided by the configuration described with reference to any of the embodiments. The invention further encompasses a configuration obtained by adding a known technology to the configuration described with reference to any of the embodiments.

The entire disclosure of Japanese Patent Application No. 2010-021284, filed Feb. 2, 2010 is expressly incorporated by reference herein.

What is claimed is:

1. A particle detector comprising:
a gas cell in which a gaseous alkali metal atom is sealed;
a light source that emits a plurality of coherent light beams containing first light and second light having different frequencies;
a light detection unit that receives light and produces a detection signal according to the intensity of the received light, the light being emitted from the light source, passing through a space in which predetermined particles can be present, and being incident on the gas cell and passing therethrough before reaching the light detection unit;
a frequency controller that controls the frequency of at least one of the first light and the second light in such a way that the first light and the second light form a pair of resonance light beams that cause the alkali metal atom to undergo an electromagnetically induced transparency phenomenon; and
an analysis assessor that performs analysis assessment of at least one of the following items based on the detection signal: whether or not the particles are present and the concentration thereof.

2. The particle detector according to claim 1,
wherein the frequency controller sweeps the frequency of at least one of the first light and the second light within a predetermined frequency range so that the first light and the second light form the pair of resonance light beams, and
the analysis assessor acquires the detection signal at multiple timings at which the difference in frequency between the first light and the second light is changed and performs the analysis assessment based on the multiple acquired detection signals.

3. The particle detector according to claim 1,
wherein the frequency controller performs the frequency control in such a way that the level of the detection signal is locally maximized, and
the analysis assessor compares the voltage of the detection signal with a predetermined threshold voltage and performs the analysis assessment based on the comparison result.

4. The particle detector according to claim 3,
wherein the frequency controller produces a modulation signal that allows the light source to undergo frequency modulation and controls the frequency of the modulation signal in such a way that the level of the detection signal is locally maximized.

5. The particle detector according to claim 1,
wherein the analysis assessor has tabulated information that defines the relationship between predetermined information on the detection signal and the concentration of the particles and performs the analysis assessment by referring to the tabulated information.

6. The particle detector according to claim 1,
wherein the light source, the gas cell, and the light detection unit are enclosed in a single enclosure,
a first window through which light can pass is provided in a first surface of the enclosure in such a way that the first window faces the light source, and a second window through which light can pass is provided in a second surface of the enclosure in such a way that the second window faces the gas cell, the second surface facing the first surface with a space which the particles can enter interposed therebetween, and
the light emitted from the light source passes through the first window and exits out of the enclosure, and the light having passed through the space, which the particles can enter, externally passes through the second window of the enclosure and is incident on the gas cell.

7. The particle detector according to claim 1,
wherein the light source, the gas cell, and the light detection unit are enclosed in a single enclosure,
a first window through which light can pass is provided in a surface of the enclosure in such a way that the first window faces the light source, and a second window through which light can pass is provided in the surface of the enclosure in such a way that the second window faces the gas cell, and
the light emitted from the light source passes through the first window and exits out of the enclosure, and the light reflected off a reflector externally passes through the second window of the enclosure and is incident on the gas cell.

8. The particle detector according to claim 1,
wherein the light source is enclosed in a first enclosure,
the gas cell and the light detection unit are enclosed in a second enclosure,
a first window through which light can pass is provided in a surface of the first enclosure in such away that the first window faces the light source,
a second window through which light can pass is provided in a surface of the second enclosure in such a way that the second window faces the gas cell, and
the light emitted from the light source passes through the first window and exits out of the first enclosure, externally passes through the second window of the second enclosure, and is incident on the gas cell.
